(19) United States
(12) Patent Application Publication
(10) Pub. No.: US 2020/0021668 A1
(43) Pub. Date: Jan. 16, 2020

(54) DYNAMIC AUGMENTED REALITY COLLABORATION SYSTEM USING A TRACKABLE THREE-DIMENSIONAL OBJECT

(71) Applicant: Merge Labs, Inc., San Antonio, TX (US)

(72) Inventor: Franklin A. Lyons, San Antonio, TX (US)

(21) Appl. No.: 16/425,571

(22) Filed: May 29, 2019

Related U.S. Application Data
(60) Provisional application No. 62/697,441, filed on Jul. 13, 2018.

(51) Int. Cl. H04L 29/06; G06T 19/00; G06T 7/285; G06T 7/70

(52) U.S. Cl. CPC H04L 67/38; G06T 7/70; G06T 7/285; G06T 19/006

(57) ABSTRACT

A collaboration and shared viewing system that is intuitive to use through manipulation of a trackable three-dimensional physical object in conjunction with a collaboration platform which allows for multiple parties to view and make changes to a virtual object, where manipulations of the three-dimensional object are mapped one-to-one to virtual object movements.

### RELATED APPLICATION INFORMATION

This application claims priority to U.S. provisional patent application number 62,697,441 entitled “Dynamic Augmented Reality Collaboration System Using a Trackable Three-Dimensional Object” filed Jul. 13, 2018 which is incorporated herein by reference.

This application is related to U.S. nonprovisional patent application Ser. No. 15/860,484 entitled “Three-dimensional Augmented Reality Object User Interface Functions” filed Jan. 2, 2018 and U.S. provisional patent application No. 62/679,146 entitled “Precise placement and animation creation of virtual objects in a user's environment using a trackable physical object” filed Jun. 4, 2018 which are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This application relates to augmented reality objects and interactions with those objects along with the physical world.

### Description of Related Art

Augmented reality (AR) is the blending of the real world with virtual elements generated by a computer system. The blending may be in the visual, audio, or tactile realms of perception of the user. AR has proven useful in a wide range of applications, including sports, entertainment, advertising, tourism, shopping and education. As the technology progresses it is expected that it will find an increasing adoption within those fields as well as adoption in a wide range of additional fields.

AR apps and software are growing in many fields and industries. Doctors, scientists, consumers, and teachers are using AR daily in their fields. A doctor can prepare for and even perform surgeries using AR in the form of AR trajectory lines or MRIs showing a path for a planned surgery. In design, virtual kitchen cabinets are placed in a new home build showing what they will look like installed. In industry, AR collaboration systems are used to demonstrate how to perform maintenance on automobiles and airplanes. Often collaboration systems offer augmented images in the form of drawing or writing on a touchscreen, and having other users see the annotations in real time. Perhaps the most broad-reaching use in VR/AR collaboration systems is in the education field, where a teacher can lead a classroom lesson, and direct an AR experience.

In industrial design, a traditional style of designing a product for manufacture is a long and costly process, often involving parties in more than one country and shipping of samples between the two. For example, a company in the U.S. using a Chinese manufacturer to engineer and produce its product might send initial specifications, receive a sample by shipment, decide the design needs to be adjusted, send directions for that adjustment, and receive a second sample by shipment. This cycle can repeat numerous times, increasing costs and delaying the start of production of the final product, particularly in the current example where time differences between the company and the manufacturer can be thirteen hours. This process could be shortened significantly and made less costly by utilizing an AR collaboration system to reduce the number of actual samples needed to achieve the desired design.

Currently available collaboration systems using AR generally include a platform on which each user can view a virtual object. Various aspects of the virtual object can be adjusted, and all users can see the adjustments to the virtual object in real time. In some collaboration systems, the virtual object in one location is anchored to a printed two-dimensional AR marker, so that the orientation and placement of the virtual object is directly related to that of the underlying AR marker. A person viewing the virtual object would have to place the AR marker on a surface and at an angle such that he can adequately see the details of the object that he is evaluating. To view details up close, he would have to physically move his viewing device physically closer to the marker. Printing an AR marker can also present some problems. The process of printing the AR marker can change the size of the AR marker slightly or significantly. The size of the virtual object is directly tied to the size of the marker. In order to display the virtual object in precise scale, the marker's exact physical dimensions must be known. If the marker is unintentionally made smaller/larger, the size of the virtual object will not be displayed in its actual dimensions. Further, as the size of the marker cannot be guaranteed in the printing process, the precision of the virtual object is not ensured. Another problem with printing an AR marker is that paper is flimsy and unstable, causing the virtual object to be shown without stability. A way to combat the instability of the printed AR marker is to place it on a table, but then the user may have to squat next to a table to get the best view of the object at the desired perspective. Further, while the user can generally turn the marker 360 degrees on a surface, and view it from the top, a view from the bottom becomes impossible with a two-dimensional marker.

Other systems allow the user to “place” the virtual object on any horizontal surface in the user's environment. The user is able to physically move around the placed virtual item to see all of its various views. While this may seem like an improvement over the system involving a two-dimensional marker, it still leaves much to be desired. Again, the user isn't able to view it from underneath, and close up details require the user to move closer to the virtual item.

What is needed is collaborative AR system where preliminary design changes can be made to a virtual product and shared with a decision maker who can determine if more changes are required; this could even be accomplished in real-time. The disclosed system makes it easier to evaluate the virtual product by using a trackable three-dimensional object, allowing a user to view all angles of a virtual object naturally as if he were holding the actual product in his hand. He could then make changes to the virtual object, and those changes would be automatically viewed by other users in the same collaboration.

In the education field, there exists currently the ability for a teacher to lead a lesson and direct students' attention to various visual aspects in the virtual or augmented world. To further engage the students, and keep the students' interest, there is needed a system that gives a student a tactile object to manipulate to see details in the associated virtual object.

### DESCRIPTION OF THE DRAWINGS

FIG. 1 shows an example of a collaboration system with three collaborators ABC where each collaborator has a cube.

FIG. 2 shows an example of an embodiment of the disclosed collaboration system between two collaborators where only one has a cube.

FIG. 3 is a flowchart that shows an example process for the embodiment illustrated in FIG. 2.

FIG. 4 shows an embodiment incorporating multiple users: xn.

FIG. 5 is a flowchart of a possible process for the multiple user embodiment shown in FIG. 4.

FIG. 6 illustrates an embodiment that incorporates redirection arrows to direct the user to adjust the cube to the desired pose.

FIG. 7 shows an embodiment of the system that includes indicators to show the user the direction in which other users are viewing the virtual object.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

A collaboration system is disclosed that is intuitive to use through manipulation of a trackable three-dimensional physical object in conjunction with a collaboration platform which allows for multiple parties to view and make changes to a virtual object, where manipulations of the three-dimensional object are mapped one-to-one to virtual object movements.

Description of Apparatus

The current system provides to a user as natural an interaction with a virtual object as he would receive if he were holding the actual item in his hand combined with the ability to make adjustments to the virtual object in collaboration with other users who are able to view (and possibly also edit) the virtual object. A user has the ability to examine the virtual object up close, naturally, from all sides and angles by holding the three-dimensional physical object closer or farther away or turning it in his hand. The system involves the use of a trackable three-dimensional object and a computing device with a processor, a display, a memory, a camera in communication, a user interface, and a network. Any parts of the computing device can be housed in one device or can be comprised of multiple devices in communication with each other.

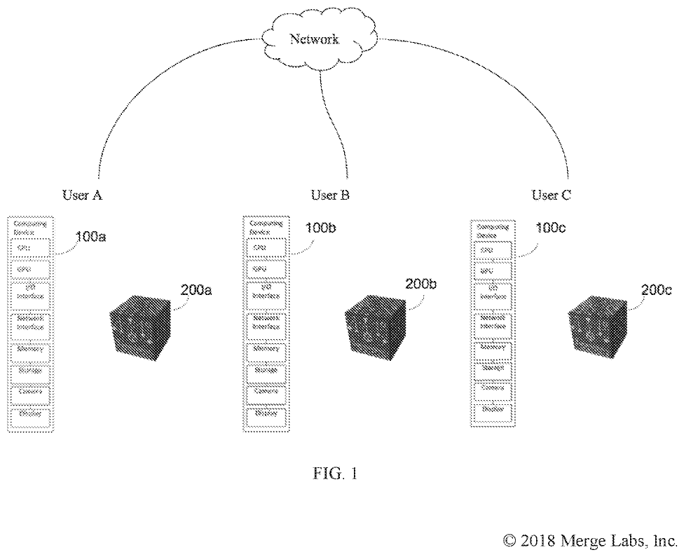

FIG. 1 shows one embodiment of the system with a computing device 100a, 100b, 100c and an example of a trackable three-dimensional physical object 200a, 200b, 200c using unique fiducial markers for tracking and anchoring the virtual object. In this example, a cube 200a is used as the three-dimensional physical object bearing six unique fiducial markers, one on each of its sides. There is no limitation that the physical object be a cube. However, a cube does present a high level of functionality. A mobile computing device 100a, such as a smartphone, usually includes all of the hardware required in the computing device to perform the collaboration system, though the system is not limited to a smartphone or even a mobile device.

Processor(s) may be implemented using a combination of hardware, firmware, and software. Processor(s) may represent one or more circuits configurable to perform at least a portion of a computing procedure or process related to three-dimensional reconstruction, Simultaneous Localization And Mapping (SLAM) or other similar software, tracking, modeling, image processing etc. and may retrieve instructions and/or data from memory. The memory may include a combination of volatile and/or non-volatile memory including read-only memory (ROM), static, dynamic, and/or magnetoresistive random access memory (SRAM DRM VRAM respectively), and nonvolatile writable memory such as flash memory. The memory may store software programs and routines for execution by the CPU or GPU (or both together). These stored software programs may include operating system software. The operating system may include functions to support the I/O interface or the network interface, such as protocol stacks, coding/decoding, compression/decompression, and encryption/decryption. The stored software programs may include an application or “app” to cause the computing device to perform portions or all of the processes and functions described herein. The words “memory” and “storage”, as used herein, explicitly exclude transitory media including propagating waveforms and transitory signals.

Storage may be or include non-volatile memory such as hard disk drives, flash memory devices designed for long-term storage, writable media, and other proprietary storage media, such as media designed for long-term storage of image data.

The camera is an electronic device capable of capturing an image of objects within its view. The camera is shown as a single camera, but may be a dual- or multi-lens camera. Likewise, the word camera is used generally to describe the camera, but the camera may include infrared lighting, a flash or other pointed light source, an infrared camera, depth sensors, light sensors, or other camera-like devices capable of capturing images or detecting three-dimensional objects within range of the camera. Though camera is described as a visual imaging camera, it may actually be or include additional or other capabilities suitable for enabling tracking. For example, lasers and/or sound may be used to perform object tracking using technologies like LIDAR and Sonar. Though neither technology involves a “camera” per se, both may be used to augment or to wholly perform object tracking in three-dimensional space.

The display is an electronic device that incorporates electrically-activated components that operate to form images visible on the display. The display may include backlighting (e.g. an LCD) or may be natively lit (e.g. OLED). The display is shown as a single display but may actually be one or more displays. Other displays, such as augmented reality light-field displays that project lights into three-dimensional space or appear to do so, or other types of projectors (actual and virtual) may be used.

The display may be accompanied by lenses for focusing eyes upon the display and may be presented as a split-screen display to the eyes of a viewer, particularly in cases in which the computing device is a part of a AR/VR headset. The AR/VR headset is an optional component that may house, enclose, connect to, or otherwise be associated with the computing device. The AR/VR headset may, itself, be a computing device, connected to a more-powerful computing device, or the AR/VR headset may be a stand-alone device that performs all of the functions discussed herein, acting as a computing device itself. Further, the augmented object could be presented through laser into the retina.

A trackable three-dimensional physical object acts as both a tangible object to naturally manipulate, as the user would if he were holding the virtual object, and a marker for insertion and tracking of a virtual three-dimensional image of an object in which the user is interested. The three-dimensional physical object can be tracked in a number of ways. One way is by having at least two sides having unique markers. The object can be a triangular prism, a pyramid, a rectangular prism, a cube, or any other three-dimensional shape. The term cube is used in the preferred embodiment of the system, but any three-dimensional object can be used in place of a cube; the system is not limited by the term cube. For brevity and to avoid confusion of the physical object and the virtual object, throughout the remainder of the description the term “cube” is sometimes used in place of “trackable three-dimensional physical object”.

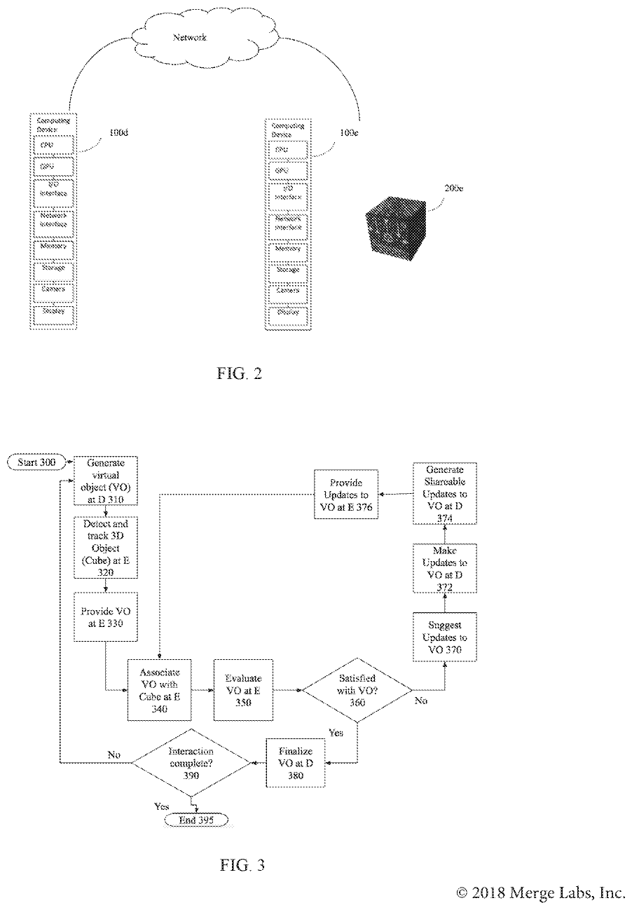

FIG. 2 shows an example of the sides of a cube 200e showing six unique markers that could be used in one embodiment of the collaboration system that uses markers for tracking. A cube has several characteristics that make it uniquely suitable for these purposes. Notably, only six sides are present, but each of the six sides may be unique and relatively differentiable from one another. For example, only six colors are required for differentiation based upon color-use or lighting-use of particular colors. This enables computer vision algorithms to easily detect which side(s) are facing the camera. Similarly, computer-readable (or merely discernable) patterns may be applied to each side of a cube without having to account for more than a total of six faces. If the number of faces is increased, the complexity of detection of a particular side—and differentiating it from other sides or non-sides—increases as well. Also, the total surface area for a “side” decreases as more sides are added, making computer vision side-detection algorithms more difficult, especially at different distances from the camera, because only so many unique patterns or colors may be included on smaller sides.

Similarly, if fewer sides are used (e.g. a triangular pyramid), then it is possible for only a single side to be visible to computer vision at a time and, as the pyramid is rotated in any direction, the computer cannot easily predict which side is in the process of being presented to the camera. Therefore, it cannot detect rotational direction as easily. And, more of each “side” is obscured by individuals holding the three-dimensional object 200e because it simply has fewer sides to hold This, again, makes computer vision detection more difficult. The cube may include at least two detection distances capable of detection by relatively low-resolution cameras in multiple, common lighting situations (e.g. dark, light) at virtually any angle. The technique of including at least two (or more) sizes of markers for use at different detection depths, overlaid one upon another in the same marker, is referred to herein as a “multi-layered marker.” The use of multiple multi-layered markers makes interaction with the cube 200 (and other objects incorporating similar multi-layered markers) in augmented reality environments robust to occlusion (e.g. by a holder's hand or fingers), rapid movement, and provides strong tracking through complex interactions with the cube 200e. In particular, high-quality rotational and positional tracking at multiple depths (e.g. extremely close to a viewing device and at arm's length or across a room on a table) is possible through the use of multi-layered markers.

All of the foregoing enables finely-grained positional, orientation, and rotational tracking of the cube 200e when viewed by computer vision techniques at multiple distances from a viewing camera. When held close, the object's specific position and orientation may be ascertained by computer vision techniques in many lighting situations, with various backgrounds, and through movement and rotation. When held at intermediate distances, due to the multi-level nature of the fiducial markers used, the object may still be tracked in position, and/or orientation, through rotations and other movements. With a high level of tracking available, the cube 200e may be replaced within an augmented reality environment with other, initialized three-dimensional objects. Interactions with the cube 200e may be translated in the augmented reality environment (e.g. shown on an AR headset or mobile device) and, specifically, to the virtual object for which the cube 200 is a real-world stand-in. The trackable three-dimensional physical object (“trackable object” or “cube”) of the disclosed system and method is highly intuitive as an interface and removes a technology barrier that can exist in more standard software-based user interfaces.

Used as part of a collaboration system, a cube allows a user to examine fine details of a virtual object for which the cube is a stand-in. The size of the virtual object is directly tied to that of the cube, so just as holding the cube close to one's face allows the viewer to see finer details of the cube itself, holding the cube closer to the camera allows the viewer to see the virtual object in finer detail, as it appears larger in the display. Any changes made by one party to the virtual object will be immediately shown to another party superimposed in three-dimensional at the position and orientation of the that party's cube. As any party moves his cube naturally in his hand, the virtual object moves the same way as viewed through the display.

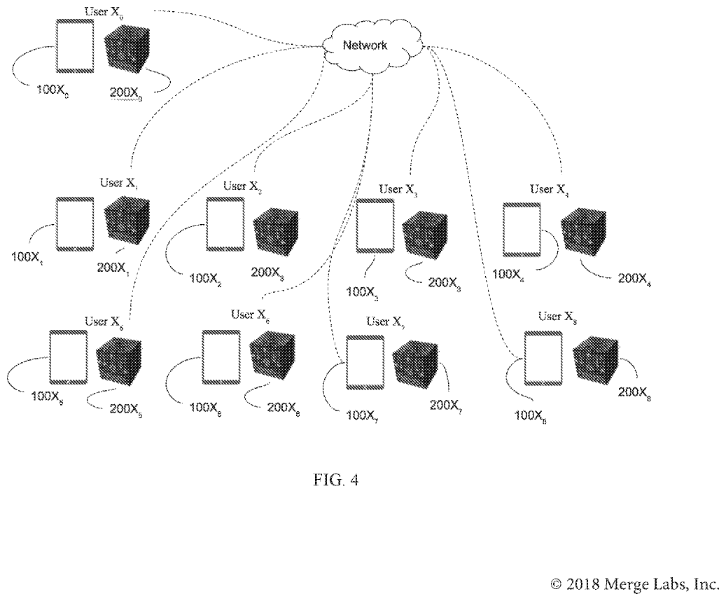

Multiple embodiments of the system are disclosed. In one embodiment, the system involves users at remote locations connected over a network, each with a computing device and cube. FIGS. 1 and 4 show examples of this type of embodiment. In some embodiments such as the example in FIG. 3, one controlling user controls editing the virtual object, but all other users can see those changes to the virtual object and suggest further modifications. In that system, the controlling user is the only user making changes. This type of collaboration system would be beneficial in industrial design where an engineer is hired to design a product or part for a product. Each iteration of the design can be shared and displayed on the cube, and alterations can be suggested by the company who hired the designer. The designer can make the changes and provide them to the company (in real-time, or at a later time) to be displayed on the cube. This cycle can continue until the company is satisfied with the product or part.

For more complex designs with intricate parts, the cube can be associated with the entire product, but also, at the user's selection, the cube can be associated with only a portion of the product. For example, a company that is creating a new AR/VR headset, might use an overseas company to produce the headset. Since shipping times are long and expensive, the company could use the disclosed system to get its product to market sooner. Rather than waiting to view any requested updates in an actual sample of the headset which could take weeks to receive, the company could receive an accurately scaled virtual headset that same day. Viewing the headset by associating its virtual image with the cube, the company can determine if further changes need to be made. If there were internal changes made, like in how the lenses of the headset fit into the outer housing, the front of the headset might be removed, or the lenses examined separately from the housing, at the election of the user. This election could be made through some recognized movement of the cube itself, or through a user interface, or through any other methods that might be obvious to one in the art.

For example, to break a virtual item up into discrete parts, a user might shake the cube. The system would recognize that movement as a request to present the parts for selection. This could be presented as a list of parts that further movement of the cube-controlled scrolling through. The parts could be exploded from the whole in a configuration where they would fit back together allowing the user to select which part to associate with the cube through a user interface, or movement of the cube near the location of the part, as viewed in the display. Many other possible ways to separate the whole virtual item into parts, and selection of one such part, are possible using the disclosed system and method.

Being able to break up the parts of a whole item is very valuable, as each part can be evaluated to determine if requested changes were made and if more changes are required. Each part can be associated with the cube at the selection of the user. Once associated, the user is able to see all sides of the part by turning it in his hand using the same natural motion he would use, were he holding the item. Examining the part or the whole item in this way is intuitive and easy for a user to implement and ensures clear communication with fewer errors.

FIG. 3 is an example flowchart of a process that may be used in the FIG. 2 system. The flow chart has both a start 300 and an end 395, but the process may be cyclical in nature. The process may take place many times while a computing device is viewing and tracking a cube or other trackable three-dimensional object. Numerous alterations to the virtual object may be made and presented. In fact, there is no limit to the number of alterations that can be made to the virtual object. In this process, sticking with the example of a designer and a company, D is the designer. The designer D creates the virtual object, alters it at company's request, and provides it to the company E. The company E evaluates the virtual object representing the product or part, and asks for alterations.

The first step in the process 305 upon starting is to generate a virtual object at 310. Generating the virtual object could include building the virtual object from specifications of the company E, or could include loading a virtual object that already exists into the collaboration system. The next step in the process is to detect and recognize the cube at 320. In one embodiment using a camera in communication with a computing device (e.g., a smartphone) along with associated software, when the cube (or other trackable three-dimensional object) is presented to the camera, the system recognizes it and tracks its motion. Often, this camera will be a camera on a mobile device (e.g. an iPhone®) that is being used as a “window” through which to experience the augmented reality environment. The camera does not require specialized hardware and is merely a device that most individuals already have in their possession on their smartphones. In this and other examples, computing device, mobile computing device, and smartphone are used interchangeably. These are merely examples; no limitations of any of the group should be imposed on the disclosure as a whole.

The cube is recognized by the camera of the computing device at 320 while the position, orientation, and motion begin being tracked. At this stage, not only is the cube recognized as something to be tracked, but the particular side, face, or marker (and its orientation, up or down, left or right, front or back, and any degree of rotation) is recognized by the computing device. The orientation is important because the associated software also knows, if a user rotates the object in one direction, which face will be presented to the camera of the computing device next and can cause the associated virtual object to move accordingly. At 320, the tracking, position, orientation and motion (including rotation) begin being tracked by the computer vision software in conjunction with the camera. Tracked movement can be translational “away from” a user (or the display or camera) or toward the user, in a rotation about an axis, in a rotation about multiple axes, to either side, or up or down. The movement may be quick or may be slow.

Next at 330, a virtual object representing the product or part that is the subject of the collaboration is provided to the company at E. This could be accomplished in a number of ways. D and E could be logged into the same collaboration “session” in an embodiment where they are working in real-time to accomplish changes in the product. In a situation where alterations are more complex and a real-time interaction is not efficient or possible (due to time differences or any other reasons), D could electronically send E the virtual object via email, text, cloud link, or any other method known in the art. At 340, once the company E has received the virtual object, the cube may be associated with it and shown on the display for evaluation at 350. Though this example highlights designing a product or part for manufacturing, it is important to note that this same process could be used across many industries that require some type of presentation of a virtual object where having a handheld manipulatable object would be beneficial. The cube may be a stand-in for a scale model of a home, a statue, an industrial part, a piece of art, or a customizable product for sale, only naming a few. The scale of the virtual object could be the real-life exact scale of the object if it is hand-held (e.g., a watch), a scaled down version if the object is large (e.g., an airplane), or a scaled-up version of the object if it is small (e.g., an earring).

Once the three-dimensional object is associated with a particular virtual object at 340, and movement of the cube is tracked, the tracked movement of the cube is updated in the associated virtual object throughout the evaluation process. This update in movement of the virtual object to correspond to movement of the cube may happen in real-time, with no observable delay. The movement is not restricted to incremental degrees or stepped, predetermined points; rather the motion of the virtual object is the natural motion of the cube in the user's hand and can be manipulated in the same way, as if holding the virtual object.

At step 350, the virtual object is inspected and evaluated. In a real-time interaction, likely both D and E would be inspecting and evaluating the virtual object for any number of qualities. Because the size of the cube is known exactly, the virtual object can be displayed in its exact size in real life in relation to the cube. A user could evaluate a virtual object for appropriateness of size with a high degree of certainty. Many elements other than size could be evaluated, such as color or overall appearance. In the case of a larger virtual item, a user can place it in its actual size in the user's environment. Whether the cube is placed on a surface in the physical environment or held in the air, the three-dimensional virtual object will be placed exactly at the location and position of the cube. This embodiment allows for very precise placement and orientation of virtual items in a user's environment which can be beneficial in evaluating the virtual object for fit in a larger system.

The cube can be in the air when the selection to anchor a copy of the virtual object is made in which case, the virtual object would appear to be floating there. If the cube is placed on a physical surface when anchoring the copy, the virtual object will appear to be standing in that exact place and position on the physical surface. The cube can be placed on a chair or on a small ledge or above a structure that the camera would not recognize as a planar surface, or up against other objects in the environment. Cubes can be stacked on top of one another. Multiple cubes could be arranged to place various virtual objects in relation to each other easily and precisely, as the cubes have a known, precise shape and can be placed exactly next to each other or other objects in a user's environment.

At 360, the user(s) has to make a decision as to whether the virtual object is satisfactory. Here the users inspect the virtual object for appropriateness in size, color, overall design, or any number of other parameters. To facilitate a more natural collaboration process, the display through which the users view the virtual object could include an avatar or other graphic indicator showing the point of view of the other collaborator. Through the ability to see what the other collaborator is viewing at any time, communication is easier as directions are more easily given; errors are eliminated because collaborators can be sure they are viewing the same sides of the virtual objects from the same angles. To further solidify a collaborator's point of view, a dotted line or other indication could show the exact angle and position from which that collaborator is viewing the virtual object. As the collaborator manipulates the cube in his hand, the dotted line indicating point of view would be updated as well.

Some embodiments of the system include the option to highlight a specific part of the virtual object to draw the attention of the other collaborator. All parties to the collaboration would have that ability to highlight specific areas to more easily facilitate communication regarding changes to be made, and to ensure that the attention of all of the parties is on the same area or part. In some embodiments, all parts of an object can be exploded and separately associated with the cube and viewed.

Using this inspection process, if the user finds the virtual object to be unsatisfactory (“no” at 360), suggestions are made at E for alterations. Suggestions could be made to change any changeable parameters of the product or part. The suggestions could be made via email or electronic message or other known methods in a situation where the interaction is not real-time. Or where the interaction is real-time, suggestions could be made via instant messaging or audio communication or any other known near instantaneous communication method. The communication component could be part of the system or separate from the system. Suggestions may come from D or E, in a truly collaborative interaction.

At step 372, D makes the suggested and agreed upon changes to the virtual object. Again, this part of the process can be done in real-time or not. The next step 374 is to generate a virtual object that has been adjusted based on the earlier suggestions from step 372. This step is only necessary if the embodiment of the system does not allow the virtual object to be shared in the same format as it is in when the designer D makes the adjustments. For example, some workable three-dimensional modeling software formats that a designer might use to adjust various components of the virtual object, may be very large requiring large amounts of computing resources and/or require specialized software to view it. In this situation, D would generate a sharable version of the virtual object in a format that could easily be associated with the cube and transferred to the company E. In some embodiments only the updates themselves would be sent to the virtual object at E, to allow for smaller amounts of information to be transferred.

At 376, D provides E with the updates to the virtual object, and the process circles back to step 340 where the now updated virtual object is associated with the cube. This updated version of the virtual object is evaluated at 350, determined whether to be deemed satisfactory at 360. If “no” at 360, the cycle continues with suggestions and alterations until it is determined at 360 that the virtual object is satisfactory. Once all parties are satisfied with the virtual object, and “yes” is chosen at 360, D finalizes the virtual object at 380. This finalization could involve any number of activities known in the art, such as saving the virtual object to a shared cloud, saving the virtual object in another location and delivering it to the company, or simply doing nothing in a system that automatically saves updated virtual objects.

At decision step 390, it is decided whether the interaction is finished. Once the process is complete, it ends at 395. The determination on whether the process is complete can be indicated in a number of ways. The software may simply be closed, or the mobile device or other computing device be put away. If so (“yes” at 390), then the process is complete at end point 395. If not, (“no” at 390), then the three-dimensional object may have been lost through being obscured to the camera, may have moved out of the field of view or may otherwise have been made unavailable. The process may continue with recognition of the cube (or other trackable three-dimensional physical object being used) and its position at 320, then the process may continue from there.

FIG. 4 shows yet another embodiment of the current system that includes multiple Users X₀₋₈, each with his own computing device 100X₀₋₈ and trackable three-dimensional object 200X₀₋₈ (e.g. a cube). In this system, different participants can have varying roles and responsibilities. For example, there can be a “leader” (User X₀) in the collaboration that guides the other participants (Xₙ) and actuates any suggested adjustments, or each of the users could have the same access and responsibilities where they may all be able to change the virtual object and share it with the other users in real time. In this FIG. 4 embodiment, all users are connected via a network, shown here as a cloud. Other methods could be used to facilitate communication, the system and method should not be limited by the network cloud in the image.

This embodiment might be useful in a teaching setting where an instructor xn could create and load the virtual object for the students to view on their displays using their own cubes both as placeholders for and trackable physical objects on which to view the virtual content. The students would be able to look at the virtual object from all directions and interact with it as described above. More complex systems could be used that allow each student to associate a different virtual object with his cube, but all participants could interact in the same world with their various virtual objects. One example for which type of system could be useful is in a classroom setting. For example, a class working together to create a story could benefit from this collaboration system. The various students could have individual characters associated with their cubes, and these characters could interact with each other to create the story. This story could be recorded on the teacher's computing device. In other embodiments, all students could share the same version of a virtual object on all of their cubes, such that changes made by one participant could be shared in real time to the other participants by updating everyone's shared associated virtual object.

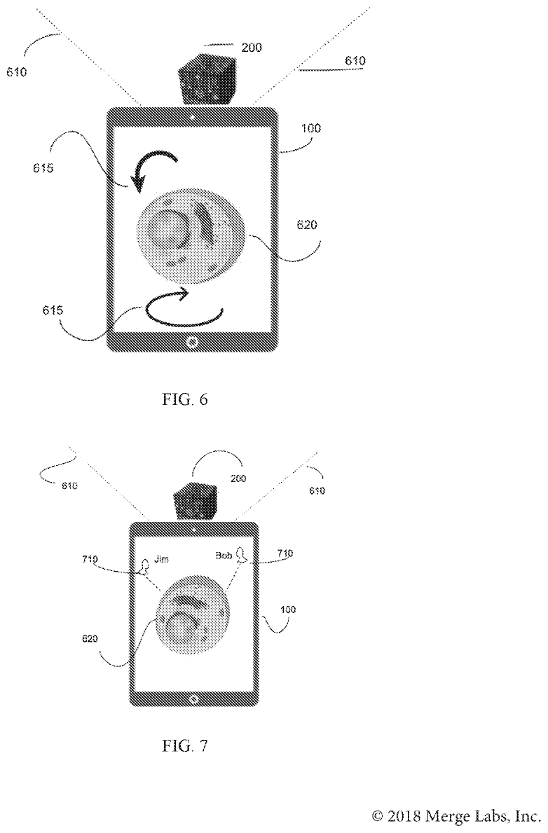

In some embodiments where a shared experience is the goal, like when a teacher is head leading the students through a virtual world or object as part of a lesson, the teacher could be able to direct the students' attention to a specific part of the virtual world or object. For example, in a science lesson covering the parts of a cell, the cube could be associated with the cell. Each student would have a handheld cell to view through a head mounted display or through the display of a computing device (e.g., a tablet, a smartphone, a laptop computer, etc.). The students could freely turn the cube in all directions in their hands to examine the cell from all angles. In discussing the various organelles, the teacher could direct students' attention to those organelles. The direction of attention could occur in many ways. FIG. 6 illustrates an example showing a student's display. Arrows 615 directing the student to turn the cell 620 in specific directions to achieve the view desired by the teacher appear at the teacher's prompting. FIG. 6 shows the mobile computing device 100 showing the cell 620 on its display in place of the cube 200 as detected and tracked by the camera; the field of view of the camera as illustrated by the dotted lines 610. The user could easily turn the cube in the direction of the arrows 615 to achieve the view desired by the teacher to follow along with the lesson. Certain areas of the object could be highlighted in the display as the teacher is discussing them to draw the students' attention to those areas. The entire object could be outlined in red until the desired view was reached, at which time the outline could turn green to indicate the desired view. In some embodiments a combination of these methods could be used. Any other method to draw the viewer's attention could be implemented with the system; the system is not limited by the examples given as they are merely illustrative of the possible embodiments of the system.

In some embodiments of the collaboration system, parts of a larger virtual object can be associated with the cube and examined independently. In the cell example mentioned above, once the teacher has the students' focus on a particular organelle, e.g. the nucleus, the cube could be associated with the nucleus itself rather than the entire cell. The students could then examine the nucleus from all angles and the teacher could highlight its parts during the lesson. The selection of the specific organelle could be achieved in various ways; some examples are by tapping on part on a touch screen if using a handheld computing device, clicking on the part using a head mounted display, staring at the part for a predetermined number of seconds if using gaze tracking functionality, moving the cube in a preset way to create an input. These are non-limiting examples, as many methods could be used in the current system. To ensure that the students are all at the desired point in the lesson, the teacher could select the nucleus to be associated with the cube, and all of the students would then see the nucleus through the display at whatever position and orientation they are holding their cubes.

To further ensure that each student's attention is at the desired view of the cell or organelle, the teacher could have the ability to see at what angle each of the students is viewing his cube. This could be done in any number of ways. FIG. 7 shows the teacher's display in an example of one embodiment. Along with the teacher's view of the virtual object 620 being shown in the display of the mobile computing device 100, the teacher could also see dotted lines (possibly leading to a named avatar) 710 showing each of the students' points of view. In this example, the teacher could see that both Bob and Jim are not looking at the part of the cell that the teacher is discussing. In some embodiments, all of the students' avatars would appear on the screen; in other embodiments, only those students whose attention was not in the desired location would appear on the teacher's display. Knowing that both Jim and Bob were not directing their attention to the lesson, the teacher could verbally redirect them, or she could initiate redirection indicators (e.g., direction arrows, highlighted areas, vibration in haptic physical objects) on their displays, prompting them to turn their cubes in specific directions to achieve the desired point of view. In some embodiments, rather than teacher-initiated, the redirection indicators such as direction arrows appear automatically when the viewpoint of the student is determined to be different than what it should be in that part of the planned lesson.

In some cases, students could choose which virtual object to view with the cube, for example the entire cell or any of its parts. There could be a menu type list of virtual objects to view. In other embodiments, the teacher would select which virtual object students could view. Many other embodiments are foreseen using this system for collaboration and shared viewing.

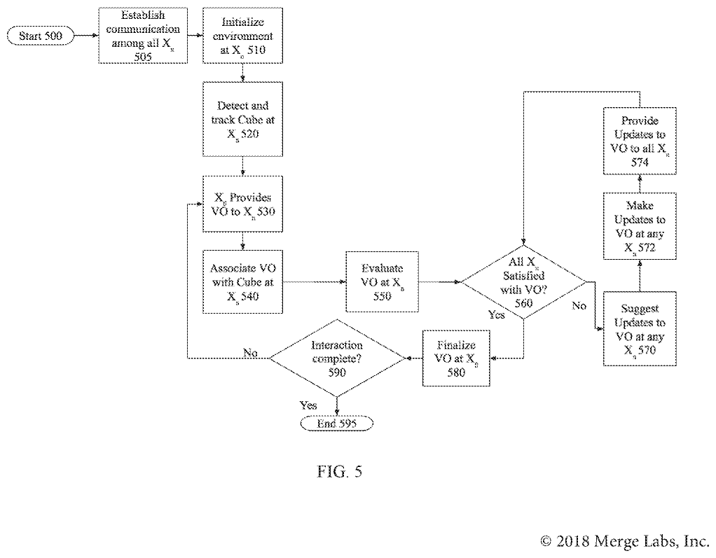

A flowchart for an example process for this multiple participant system is shown in FIG. 5. The process is very similar to the one outlines in FIG. 3. The process starts at 500, ends at 595 and is cyclical in nature much like the process charted in FIG. 3. The first step of the process begins at 505 with establishing a connection among the various participants. The connection could be made in many ways known in the art (LAN—Local Area Network, WAN—Wide Area Network, WLAN—Wireless Local Area Network, MAN—Metropolitan Area Network, SAN—Storage Area Network, System Area Network, Server Area Network, or sometimes Small Area Network, CAN—Campus Area Network, Controller Area Network, or sometimes Cluster Area Network, PAN—Personal Area Network, or any other means of connection and information sharing known in the art or developed). In some embodiments all X are in communication with each other, but in other embodiments, the leader Xo is connected to each other participant, but the other participants are not communicatively connected to each other. Another method of communication could be server-based. The leader could create a session that has a unique code that allows other participants to join the session. This method is particularly useful in situations in which participants are not on the same network, or even in the same country.

Once communication is established, the process from this point on is much the same as that outlined in FIG. 3. With steps appearing in the process describing figures being assigned three-digit designators, where the most significant digit is the figure number, and the two least significant digits are specific to the step in the process. Each step not described for FIG. 5 can be presumed to have the same characteristics and functions as previously-described step having a reference designator with the same least significant digits. So the process cycles then cycles through detecting and tracking the cube at all stations User Xₙ at 520. In embodiments with a leader X₀, X₀ provides all User Xₙ with a virtual object(s). At 540, at each xn, the virtual object is associated with the cube at that location. Evaluation 550 follows at each location, and the process continues as described above. The key difference in this process versus the earlier discussed process in FIG. 3 is that multiple users of the system Xₙ could make the changes and all of the other users would see the changes. In this system with multiple users, the changes could be made in real-time, or delayed. Also there need not be any changes made in the embodiment where the goal is a shared experience (such as the classroom example with the animal cell as the virtual object to be examined) rather than the more industrial application of designing a product.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A collaboration system for shared viewing of a three-dimensional virtual object comprising:
a first computing device comprising a first memory, a first processor, and a first display, and a first camera; and
a three-dimensional physical object in a field of view of the first camera, wherein the first processor of the first computing device is configured to:
capture an image of the three-dimensional physical object;
generate a three-dimensional virtual object for display in place of the three-dimensional physical object corresponding to the location, position, and orientation of the three-dimensional physical object as viewed from the perspective of the first camera;
instruct a network connection to transmit data regarding the three-dimensional virtual object to a second computing device for display on a second display in communication with the second computing device, the data comprising a location, position, and orientation of the three-dimensional physical object from the perspective of the first camera along with data indicating associated characteristics of the three-dimensional virtual object such that translation and rotation of the three-dimensional physical object detected by the first computing device corresponds to translation and rotation of the three-dimensional virtual object in the second display.

2. The system of claim 1, wherein the processor of the first computing device updates the three-dimensional virtual object in response to input from a first user interacting with the first display or a second user interacting with the second display.

3. The system of claim 1, wherein the three-dimensional physical object is a cube bearing a unique fiducial marker on each of its six sides.

4. The system of claim 1, wherein a virtual translation and a virtual rotation of the three-dimensional virtual object is updated in response to the translation and the rotation.

5. The system of claim 1 wherein the first processor transmits any changes to an appearance of the three-dimensional virtual object made by interaction with the three-dimensional physical object to the second computing device for display.

6. A collaboration system for shared viewing of three-dimensional virtual objects comprising:
a plurality of computing devices, each comprising a memory, a processor, a display, a user interface, and a camera, and in communication with a network;
a plurality of trackable three-dimensional physical objects for use with the plurality of computing devices, wherein the processor of each of the plurality of computing devices:
detects and tracks a location and orientation of each of the plurality trackable three-dimensional physical object using the camera; replaces the trackable three-dimensional object in the display with an associated three-dimensional virtual object, wherein the same virtual object is displayed on each of the plurality of computing devices, and wherein the tracked movement of the trackable three-dimensional physical object determines corresponding movement in the virtual objects for each display for each of the plurality of computing devices.

7. The system of claim 6, wherein changes made to the virtual object on the user interface of any of the plurality of computing devices are received and displayed on each display of each of the plurality of computing devices.

8. The system of claim 6, wherein the trackable three-dimensional physical object is a cube bearing unique markers on each of its sides.

9. The system of claim 6, wherein the changes to the virtual object made on the user interface of any of the computing devices are updated on the plurality of computing devices.

10. A method for shared viewing of a three-dimensional virtual object comprising:
capturing, using a camera in communication with a first computing device, an image of a three-dimensional physical object in a field of view of the first camera;
generating a three-dimensional virtual object for display in place of the three-dimensional physical object corresponding to the location, position, and orientation of the three-dimensional physical object as viewed from the perspective of the camera; and
transmitting data regarding the three-dimensional virtual object to a second computing device for display on a second display in communication with the second computing device, the data comprising a location, position, and orientation of the three-dimensional physical object from the perspective of the camera along with data indicating associated characteristics of the three-dimensional virtual object such that translation and rotation of the three-dimensional physical object detected by the first computing device corresponds to translation and rotation of the three-dimensional virtual object in the second display.

11. The method of claim 10 further comprising updating the three-dimensional virtual object in response to input from a first user interacting with a first display in communication with the first computing device or a second user interacting with a second display in communication with the second computing device.

12. The method of claim 10, wherein the three-dimensional physical object is a cube bearing a unique fiducial marker on each of its six sides.

13. The method of claim 10, wherein a virtual translation and a virtual rotation of three-dimensional virtual object is updated in response to the translation and the rotation.

14. The method of claim 10, wherein any changes to an appearance of the three-dimensional virtual object made by interaction with the three-dimensional physical object are transmitted to the second computing device for display.
